(19) United States
(12) Patent Application Publication
(10) Pub. No.: US 2002/0096812 A1
(43) Pub. Date: Jul. 25, 2002

(54) Bench vice or clamp

(75) Inventor: Philip Reed, Sheffield (GB)

Correspondence Address: BRINKS HOFER GILSON & LIONE, P.O. Box 10395, Chicago, IL, 60610, US

(73) Assignee: Record Tools Limited

(21) Appl. No.: 09/940,844

(22) Filed: Aug. 28, 2001

(30) Foreign Application Priority Data
Jan. 22, 2001 (GB) 0101566.8

(51) Int. Cl. B25B 1/02

(52) U.S. Cl. 269/173

(57) ABSTRACT

Vice comprising a moveable jaw mounted on a screw-threaded main vice screw which is axially fixed but rotatable within said moveable jaw, a fixed jaw mounted on the main vice screw, the jaws being moveable toward or away from one another upon rotation of the main vice screw, the vice further comprising a screw-threaded quick release mechanism moveable between a closed position in which the screw-thread of the quick release mechanism engages the screw-thread of the main vice screw and an open position in which the screw-thread of the quick release mechanism is disengaged from the main vice screw enabling the main vice screw to be moved freely axially with respect to the fixed jaw, the movement between the closed and open positions being effected automatically upon rotation of the main vice screw.

### BACKGROUND OF THE INVENTION

This invention is in the field of bench vices or clamps including an improved mechanism for rapidly adjusting the relative position of its jaws.

Throughout this application, general reference to a “vice” includes a bench vice, clamp or other such clamping device.

A conventional vice comprises a fixed jaw and a moveable jaw, which are brought together or moved apart by moving the moveable jaw with respect to the fixed jaw along a screw-threaded bar (the “screw”). The screw is axially fixed with respect to the moveable jaw but is freely rotatable within the moveable jaw. The screw is engaged with a corresponding screw-thread in the fixed jaw.

The movement of the jaws is generally effected by rotating a tommy bar which, in turn, rotates the screw. This causes the screw to advance through the fixed jaw by virtue of the co-operating screw-threads therein which means that the moveable jaw (which is axially fixed to the screw) advances toward or away from the fixed jaw (depending upon the direction of rotating the tommy bar).

When it is desired to cramp an object in the vice's jaws, the user must hold the object in the space between the jaws whilst turning the tommy bar in order to advance the moveable jaw toward the fixed jaw (and the object held in between). When the removeable jaw reaches the object and holds it against the fixed jaw, clamping is effected. It can be rather slow to advance the moveable jaw to clamp the object effectively, especially if the jaws are wide apart initially. Indeed, when the jaws are wide open but it is desired to clamp a small object, it is time-consuming to wind the screw until the jaws approach the object.

Furthermore, when it is desired to release the object from the jaws, depending on the size and shape of the object, the tommy bar may have to be turned for an inconveniently long time in order to move the moveable jaw sufficiently away from the fixed jaw in order to release the object.

This problem is alleviated by a known type of vice which incorporates a “quick-release” mechanism. Instead of the screw-threaded main vice screw permanently engaging with a screw-thread on the interior of the fixed jaw, the fixed jaw screw-thread comprises a screw-threaded half nut which is, normally, urged into engagement with the main vice screw, for example by means of a spring. When it is desired to actuate the “quick-release” mechanism, a lever pushes the half nut away from the main vice screw by overcoming the force of the spring. In this way the main vice screw is released from engagement with the half nut, allowing the main vice screw to be moved axially free of the fixed jaw. The lever is actuated, on demand, by the vice operator which can be inconvenient since he may already need his hands to operate the tommy bar and/or support the object which is about to be released from or indeed clamped in, the vice.

Furthermore, because it is merely a spring which presses the half nut into engagement with the threaded screw, the threads must be somewhat radial to reduce the tendency for the threads to have a radially outward component of reaction, causing the half nut potentially to spring off the vice screw, when the tommy bar is very tightly clamped. Radial screw-threads are expensive to produce and cannot satisfactorily be roll-formed.

It is therefore an object of the present invention to provide an improved mechanism for rapidly adjusting the relative position of the jaws of a vice which alleviates the above-described problems.

### SUMMARY OF THE INVENTION

According to a first aspect of the present invention there provided a vice comprising a moveable jaw mounted on a screw-threaded main vice screw which is axially fixed with respect to said moveable jaw but is rotatable within it, a fixed jaw mounted on the main vice screw, the jaws being moveable toward or away from one another upon rotation of the main vice screw, and a quick release mechanism including a screw-threaded element moveable between a closed position in which the screw-threaded element engages the screw-thread of the main vice screw and an open position in which the screw-threaded element is disengaged from the main vice screw enabling the main vice screw to be moved freely axially with respect to the fixed jaw, the movement between the closed and open positions being effected by rotation of the main vice screw.

Preferably, said quick release mechanism further comprises an actuator disposed on said main vice screw which urges said screw-threaded element into engagement with the main vice screw when the main vice screw is rotated in a direction that brings the vice jaws towards one another. Ideally, said actuator is a frictional fit on said main vice screw. Further preferably, the actuator further comprises a retaining hook for maintaining the relative axial position of the actuator and said screw-threaded element.

In a preferred form, said actuator is a leaf spring comprising a collar around the main vice screw, and elongate leaves which move said screw-threaded element into and out of engagement with said main vice screw.

Preferably, said mechanism comprises a nut body, and said actuator is mounted on said nut body for movement relative thereto. Ideally, said nut body is fixed in the fixed jaw and comprises a sleeve which is a sliding fit on the main vice screw.

In a preferred form the nut body comprises cam surfaces over which the elongate leaves can travel in order to effect said movement.

Preferably, said screw-threaded element comprises two half nuts which, in the closed position, substantially surround the main vice screw. Ideally the half nuts are mounted in the nut body.

Preferably, the half nuts are pivotally mounted so as to enable them to pivot between the open and the closed positions. In a preferred form, the quick release mechanism, when it is in said engaged position, is axially shiftable between axial limits in the fixed jaw by rotation of the main vice screw, said limits defining a first locked position, wherein said mechanism is prevented from moving to said disengaged position, and an unlocked position in said mechanism can move to said unlocked position. Preferably, said actuator is chamfered and engages a corresponding chamfer in said nut body when in said first locked position.

Preferably, it is an internal circumferential edge of the sleeve which is chamfered.

According to a second aspect of the invention there is provided a vice comprising a moveable jaw mounted on a screw-threaded main vice screw which is axially fixed with respect to said moveable jaw but is rotatable within it, a fixed jaw mounted on the main vice screw, the jaws being moveable toward or away from one another upon rotation of the main vice screw, and a quick release mechanism including a screw-threaded element moveable between an engaged position in which the screw-threaded element engages the screw-thread of the main vice screw and a disengaged position in which the screw-threaded element is disengaged from the main vice screw enabling the main vice screw to be moved freely axially with respect to the fixed jaw, in which the mechanism, when it is in said engaged position, is axially shiftable between axial limits in the fixed jaw by rotation of the main vice screw, said limits defining a first locked position, wherein said mechanism is prevented from moving to said disengaged position, and an unlocked position in said mechanism can move to said unlocked position.

According to a third aspect of the invention, there is provided a quick release mechanism for use in a vice as described in any of the preceding paragraphs.

### BRIEF DESCRIPTION OF THE DRAWINGS

Preferred embodiments of the present invention will now be more particularly described, by way of example only, with reference to the accompanying drawings, in which:

FIG. 1 is an isometric assembly view of a vice incorporating a quick release mechanism, shown through a cut-away window. In this view, part of the moveable jaw has a window cut therein to enable components within to be illustrated and, similarly, the adjacent part of the fixed jaw is also omitted from this view;

FIG. 2A is a side view of one of the half nuts;

FIG. 2B is an end view of one of the half nuts;

FIG. 2C is a bottom view of one of the half nuts;

FIGS. 2D and 2E are perspective views of one of the half nuts;

FIG. 3 is a perspective view of the leaf spring;

FIG. 4 is a perspective view of the nut body;

FIG. 5 is an end view of the nut body;

FIG. 6 is a side view of the nut body;

FIG. 7 is a top view of the nut body;

FIG. 8 is a perspective view of the assembled mechanism, with the half nuts closed;

FIG. 9 is a perspective view of the assembled mechanism, with the half nuts open;

FIG. 10 is a side view of the assembly shown in FIG. 1; and

FIG. 11 is a side sectional view of the assembly shown in FIG. 1.

### DETAILED DESCRIPTION OF THE PREFERRED EMBODIMENT

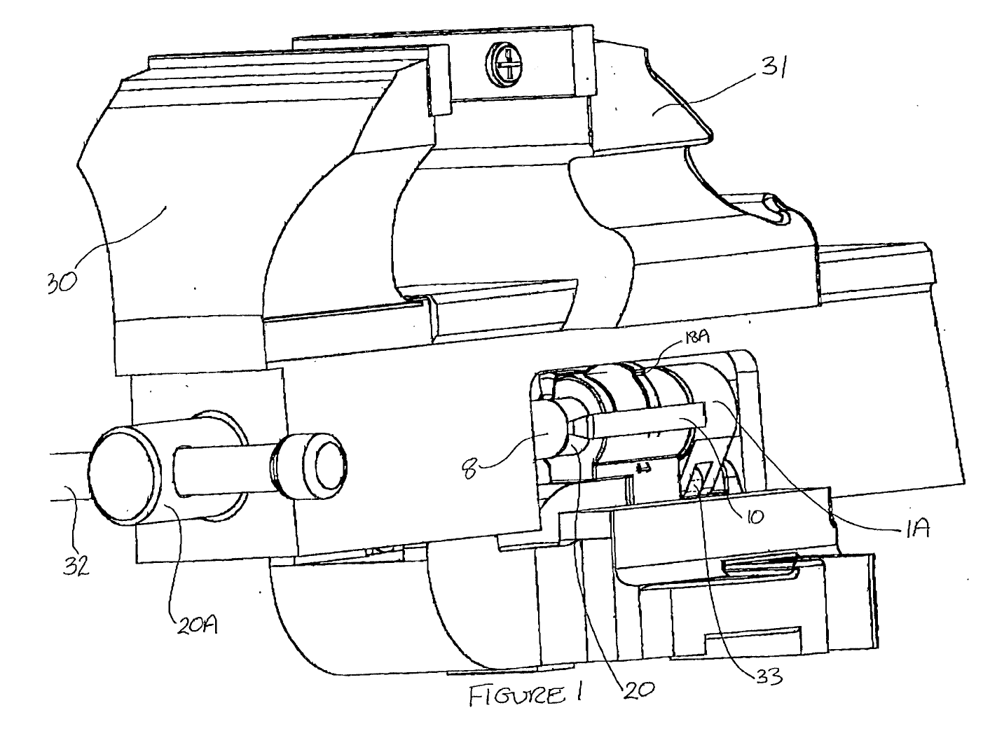

FIG. 1 shows a bench vice having a conventional moveable jaw 30 and a fixed jaw 31 between which an object (not shown) can be clamped. A main vice screw 20, having an enlarged head 20A at one end passes through both of the jaws 30, 31. The main vice screw is screw-threaded and is axially fixed with respect to the moveable jaw 30 but is rotatable therein by turning a tommy bar 32.

The end of the main vice screw distal from the movable jaw is enclosed by the components visible through the cut-away window in FIG. 1. Two half nuts (one of them, item 1A, is visible in FIG. 1) closely surround the main vice screw 20. The half nuts have a screw-thread on their interior surfaces and these normally engage with the screw-threaded main vice screw 20.

When it is desired to clamp an object in the vice's jaws, an operator turns the tommy bar 32 in a clockwise direction which rotates the main vice screw 20 so that the screw-thread thereon advances through the screw-thread on the interior surfaces of the half nuts. This causes the moveable jaw 30 to advance toward the fixed jaw 31 until sufficient clamping force is applied to the object.

The components visible through the cut-away window comprises a quick release mechanism which will be described in more detail once each component has been identified.

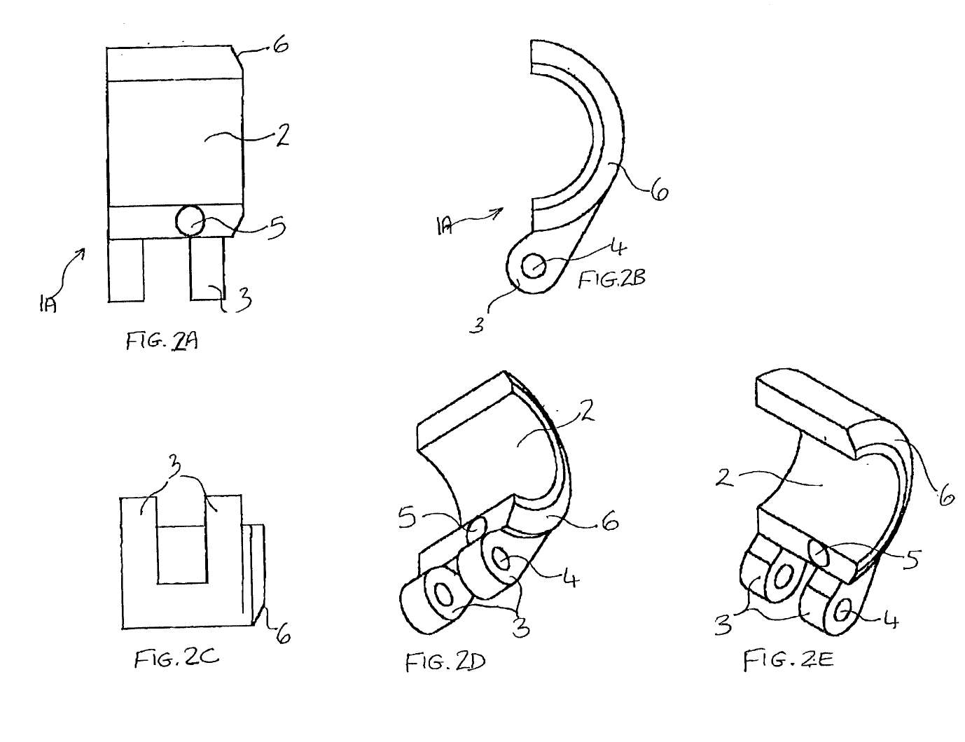

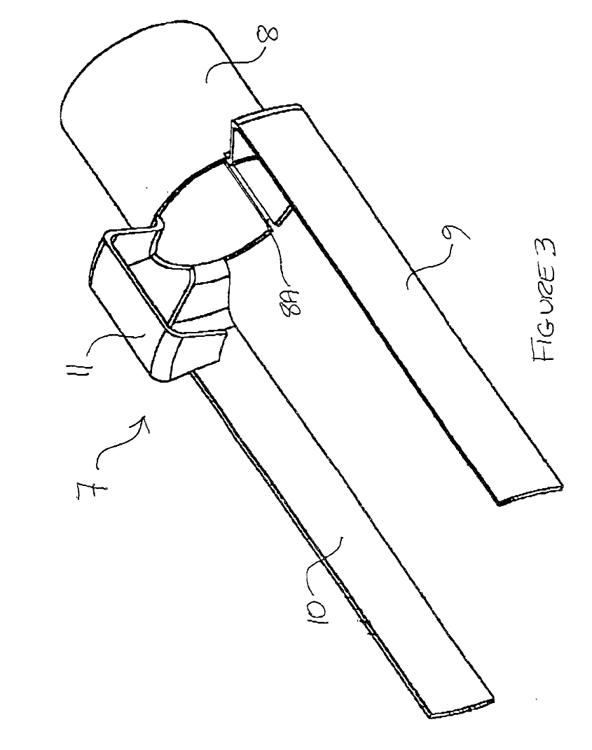

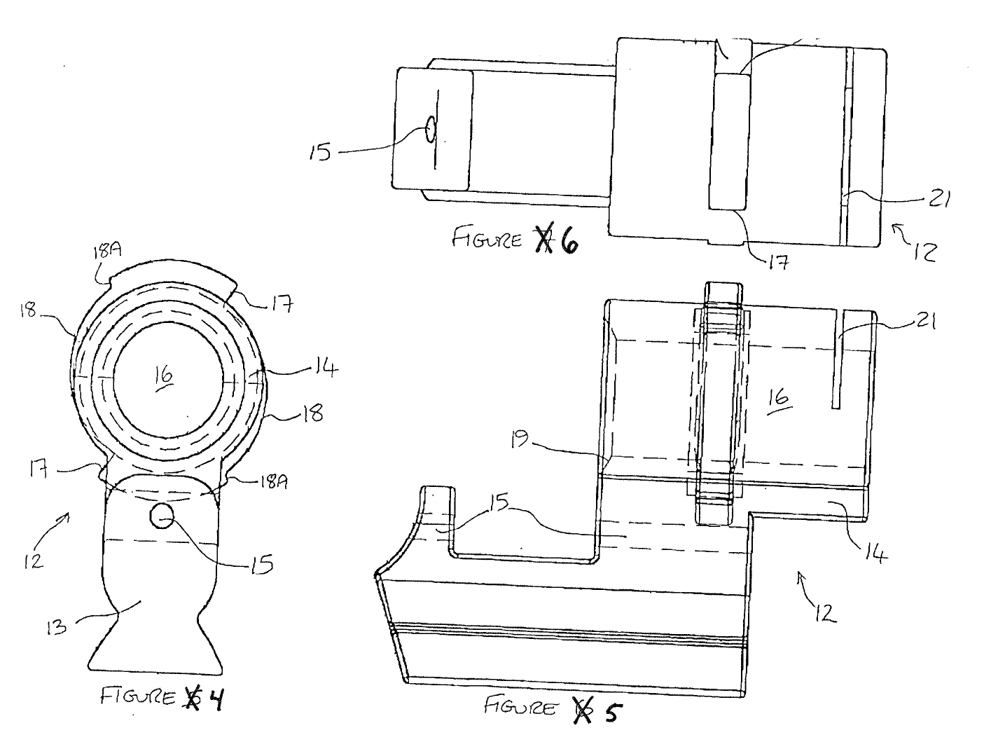

Referring now to FIGS. 2A-2E, one of the two half nuts 1A is illustrated. The half nut 1A is substantially semi-circular in shape and has a suitable radius to allow it to surround half of the main vice screw 20 (as shown in FIG. 1 for example). The interior surface of the halt nut is provided with a screw-thread 2 which can engage with the screw-thread on the main vice screw 20. Two mounting loops 3 are provided at the lower edge of the half nut, having apertures 4 through which the half nut can be mounted on a hinge pin (item 33 in FIG. 1) The second half nut (not illustrated in FIGS. 2A-2E) has only one mounting loop which is of a suitable size to fit between the mounting loops 3 of half nut 1A, in use. In this way, both half nuts can be mounted on the same hinge pin.

A blind hole 5 is provided on each half nut for receiving one end of a lightweight compression spring. In use, this compression spring, mounted between the two half nuts tends to push the half nuts apart in the absence of any other forces.

One edge of the half nut 1A is provided with a chamfer 6.

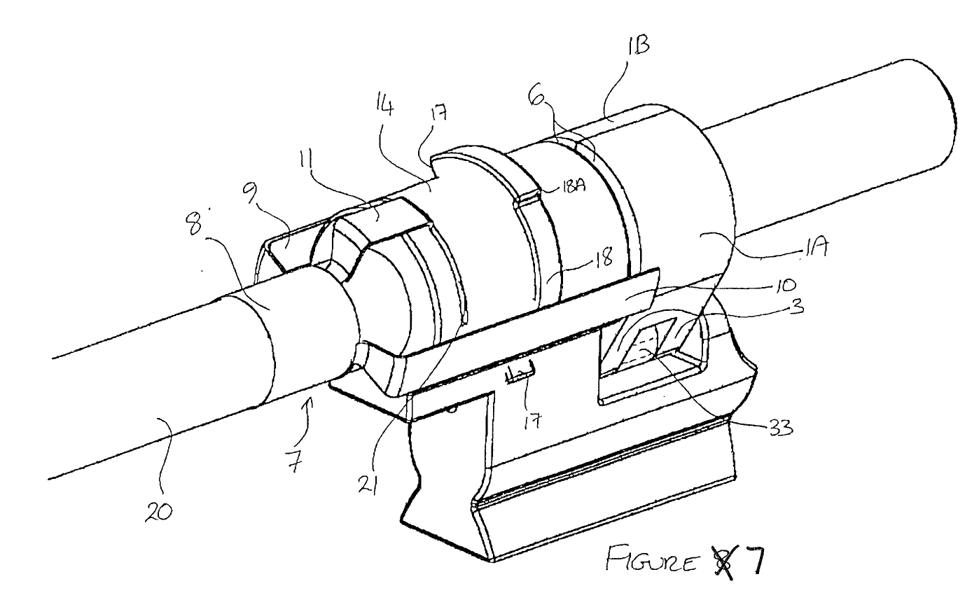

Referring to FIG. 3, another component of the quick release mechanism is a leaf spring 7 comprising an end collar 8 which, in use, surrounds the main vice screw 20, two opposed elongate leaves 9, 10 and a retaining hook 11. The collar 8 has an elongate slot 8A therein.

FIG. 4 shows another component of the quick release mechanism, which is a nut body 12. The nut body comprises two sections—a lower base section 13 and an upper cylindrical section 14. The base section has an aperture 15 therein for receiving the hinge pin 33 on which the two half nuts can be mounted (see FIG. 1).

The upper section 14 has a clearance bore 16 therethrough which is of sufficient diameter to surround but not interfere with the main vice screw. The upper section also includes spring stops 17 and cam surfaces 18 on the outer surface thereof which are designed to interact with the leaf spring.

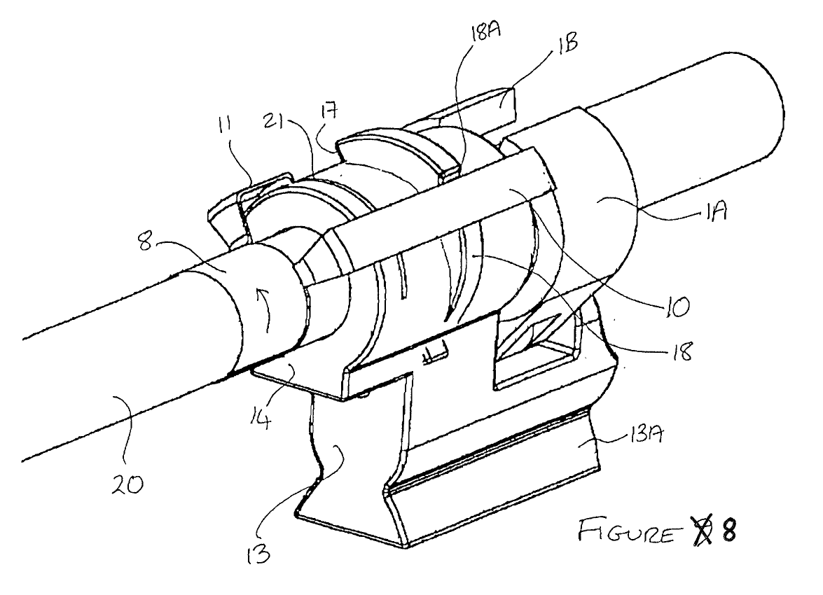

As can be seen more clearly from FIG. 5, the nut body includes two sets of cam surfaces 18 and spring stops 17 which are diametrically opposed on the upper section 14. The cam surfaces 18 each comprise a ramp which, as one travels clockwise around the cylindrical upper section 14 (as viewed in FIG. 5), increases in height from the centre of the cylindrical upper section. At the “top” of each ramp i.e. where the cam surface 18 has maximum height, is provided a small end stop 18A. At the “bottom” of each rams i.e. where the cam surface 18 has minimum height, is provided an end stop 17 which, since it is used to restrict movement of the leaf spring in use, is referred to as a spring stop.

FIG. 6 is a side view of the nut body from which can be seen more clearly the aperture 15 for receiving the hinge pin (not illustrated). The clearance bore 16 in the upper section 14 is also shown in dotted lines. The leftmost end of the clearance bore (as illustrated in FIG. 6) has a chamfer 19 which, in use, will cooperate with the chamfer 6 on the edge of the half nuts 1A, 1B.

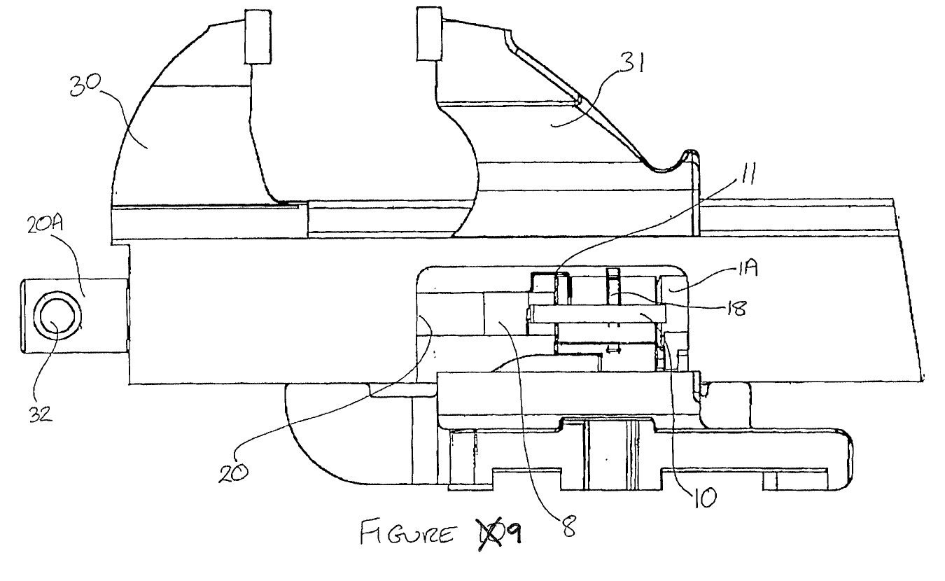

FIG. 7 is a too view of the nut body from which can be seen a slot 21 on the upper section, into which the retaining hook 11 of the leaf spring can engage in use.

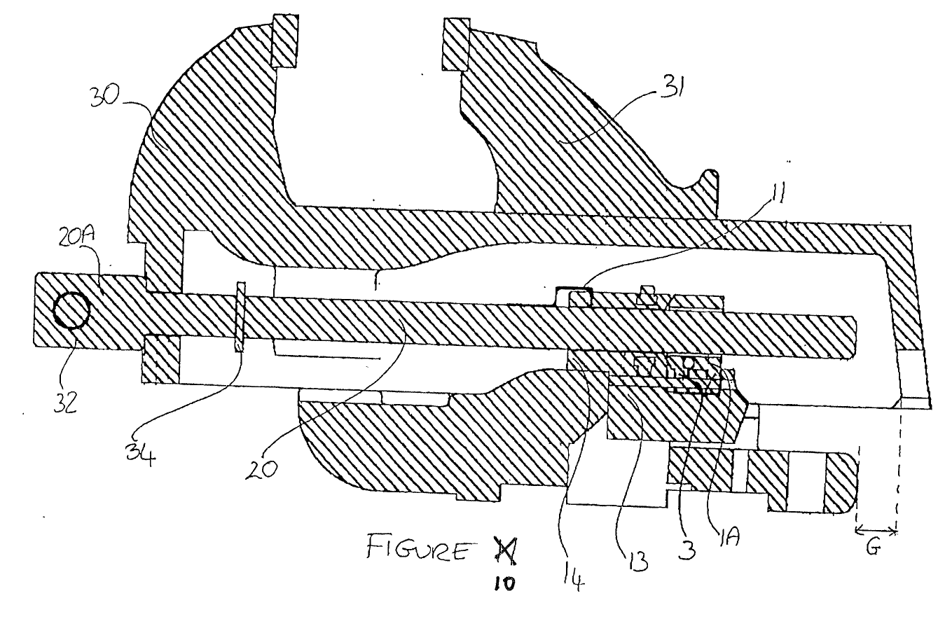

FIGS. 8 and 9 show how the half nuts, leaf spring and nut body are assembled together. Referring firstly to FIG. 8, the leaf spring 7 is mounted on the main vice screw 20 with the end collar 8 surrounding the main vice screw. The collar 8 is sprung apart at slot 8A to assemble the spring 7 on the main vice screw 20 and so that it firmly grips the main vice screw. The upper section 14 of the nut body is positioned with the screw 20 passing through clearance bore 16. The two half nuts 1A, 1B are mounted on the hinge pin 33 which passes through the aperture 15 in the nut body and the mounting loops 3 of the half nuts.

FIG. 8 shows the assembly with the half nuts 1A, 1B in a “closed” position, i.e. wherein they closely surround the main vice screw 20, the screw-thread 2 on the half nuts being engaged with the screw-thread on the main vice screw. In this position, the retaining hook 11 of the leaf spring is engaged in the slot 21 on the upper section 14 of the nut body. The ends of the elongate leaves 9, 10 are in contact with the cam surfaces 18 on the nut body and press against the half nuts 1A, 1B so as to retain them in the closed position, in engagement with the main vice screw 20. The chamfer 19 on the nut body faces the chamfers 6 of the half nuts 1A, 1B. Clockwise rotation of the main vice screw draws the half nuts along the hinge pin 33, their hinge bores 4 being a sliding fit on the pin 33, until the chamfers 19, 6 engage one another. Rotation of the leaf spring 7 is limited by the abutment of the elongate leaves 9, 10 with spring stops 17, after which the collar 8 slips over the main vice screw 20 which may continue to be rotated under it.

When the main vice jaws 30, 31 grip an object between them, further rotation of the tommy bar 32 both clamps the object more tightly and draws the half nuts 1A, 1B into the chamfer 19 of the nut body so that, although the threads of the screw may attempt to spread the half nuts, the chamfer 19 through its engagement with the chamfers 6 on the half nuts, prevents the half nuts from opening. Indeed, this is such that an ordinary rolled screw-threaded screw can be employed, because precisely radiussed threads need not be used.

The half nuts 1A, 1B can be moved from the “closed” position shown in FIG. 8 to an “open” position, shown in FIG. 9. Anticlockwise rotation of the main vice screw 20 initially causes the chamfers 6, 19 on the nut body and half nuts to be disengaged from one another i.e. they move slightly axially away from one another. The anticlockwise rotation of the main vice screw causes the collar 8 to move in the direction indicated by an arrow in FIG. 9. This causes the retaining hook 11 to slide in its slot 21 and the elongate leaves 9, 10 to ride up the cam surfaces 18. As the ends of the elongate leaves ride up the cam surfaces, they are urged outwardly away from the half nuts 1A, 1B which causes the half nuts to fall away from their engagement with the screw 20. Rotation of the leaf spring 7 is limited when the elongate leaves 9, 10 abut the end stops 18A.

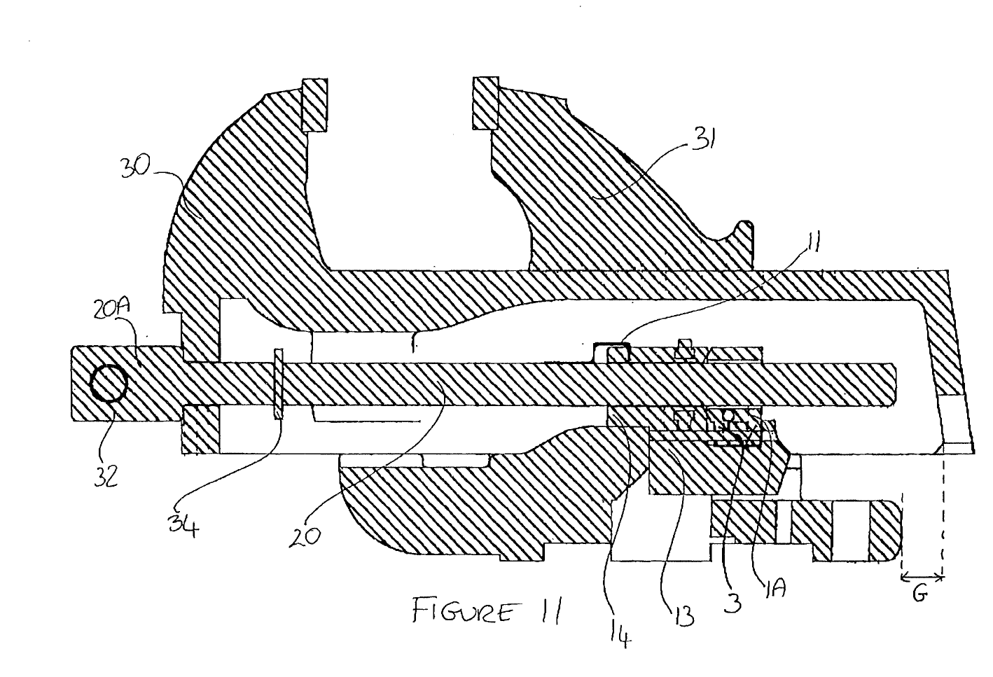

The lower base section 13 of the nut body has, as can be seen in FIG. 9, a dovetail section 13A and this dovetail section slides into a suitably shaped recess in the fixed jaw of the vice in order to assemble the two together as illustrated in FIGS. 1, 10 and 11.

Referring now to FIGS. 1, 10 and 11, the operation of a vice incorporating the quick release mechanism will be described.

When it is desired to release an object from the vice jaws, the tommy bar 32 and hence the main vice screw 20 is turned in an anti-clockwise direction. This causes the collar 8 to turn in an anti-clockwise direction with the main vice screw 20. The elongate leaves 9,10 ride up the cam surfaces 18, away from the spring stops 17, which causes the leaves to spread outwardly away from the half nuts 1A. 1B. The half nuts are therefore free to drop out of engagement with the main vice screw 20 (i.e. into the “open,” position described above), once the chamfers 6, 19 have disengaged. A compression spring mounted in the blind holes 5 (described above with reference to FIGS. 2A-2E) may initiate the movement of the half nuts apart, if gravity does not suffice.

Once the screw-thread on the half nuts is disengaged from the screw-thread on the main vice screw 20, the main vice screw is free to be moved axially with respect to the fixed jaw 31, without the need to continue lengthy winding of the tommy bar. In this way, the grip on the object can be rapidly released giving an advantageous time saving over a conventional vice. Indeed, once the half nuts are disengaged from the main vice screw, the main vice screw (and hence the moveable jaw) can be rapidly moved axially either toward or away from the fixed jaw.

When it is desired to clamp an object in the vice, the object is positioned between the fixed screw 31 and moveable jaw 30, and the moveable jaw is slid forwardly until it contacts the object and the fixed jaw. The tommy bar 32 is then turned clockwise. When the tommy bar is initially turned (clockwise with reference to FIG. 1), the main vice screw 20 turns the collar 8 of the leaf spring clockwise, because the collar is a friction fit on the main vice screw. As the collar 8 turns clockwise, the ends of the elongate leaves 9, 10 move down the cam surfaces 18, away from end stops 18A and toward spring stops 17. As the height of the cam surfaces decrease, the elongate leaves move inwardly, bringing the half nuts 1A, 1B back into engagement with the main vice screw 20. When the elongate leaves abut the spring stops 17, the screw-thread on the half nuts is fully engaged with the main vice screw. Continued turning of the tommy bar draws the half nuts into engagement with the upper section 14 of the nut body to prevent opening of the nut halves, (as described above). The collar 8 slips over the main vice screw 20, which continues to rotate under it and advances through the half nuts (and hence the fixed jaw), bringing the jaws finally together in a conventional manner until the object is clamped between them.

The quick release mechanism of the present invention could either be built into a bench vice or clamp, or be retro-fitted to a conventional bench vice or clamp.

The ease with which the quick release mechanism can be retro-fitted to a conventional bench vice is particularly advantageous and will be described with reference to FIG. 11. FIG. 11 shows a vice including the quick release mechanism but, in a conventional vice, there would instead be a simple nut body having a screw-thread on the interior thereof. The conventional nut body has a similar dovetail connection to the fixed jaw as described above. The main vice screw 20 passes through the nut body so that the screw-thread on the main vice screw engages with the interior screw-thread on the nut body.

When it is desired to remove the conventional nut body from the vice, it is necessary to maximise the gap G between the base of the fixed jaw and the rear of the moveable jaw as this is the gap through which the nut body will be removed. Gap G is maximised, firstly, by removing a clip 34 which normally prevents the main vice screw 20 from moving axially with respect to the moveable jaw 30. The main vice screw 20 can teen be unscrewed from the nut body (by rotating the tommy bar 32 in an anti-clockwise direction) and moved leftwards (as illustrated in FIG. 11) so that the main vice screw is completely free of the nut body.

The moveable jaw 30 can then be moved as far right as possible (as illustrated in FIG. 11) i.e. until the moveable jaw abuts the fixed jaw 31 and can move no further right.

At this point the gap G is maximised and the conventional nut body can be removed. This is done by releasing any fixings which hold the nut body in place and then using the main vice screw to push the nut body rightwardly (as illustrated in FIG. 11) so that it can drop out of the vice through gap G.

A quick release mechanism as described above can be installed in place of the conventional nut body by reversing the above-described process. The nut body 12 including half nuts 1A, 1B and leaf spring 7 is inserted into the vice through maximised gap G and the dovetail section 13A of the nut body 12 Is slid into a corresponding recess in the fixed vice. Fixings can then be applied to hold the nut body in place. The moveable jaw 30 is then slid leftwards, away from the fixed jaw 31 to the position illustrated in FIG. 11. The main vice screw 20 is then slid rightwards toward the nut body and inserted through the clearance bore 16 and half nuts. Finally the clip 34 is replaced.

In summary, the quick release mechanism provides a convenient, self-actuating way to release an object from the vice jaws. When the tommy bar is rotated in an clockwise direction, the half nuts engage the main vice screw in order to drive the jaws together. When the tommy bar is rotated in an anti-clockwise direction, the half nuts automatically drop out of engagement with the main vice screw to enable the jaws to be pulled rapidly apart.

What is claimed is:

1. Vice comprising:
a screw-threaded main vice screw;
a moveable jaw mounted on said main vice screw and axially fixed with respect thereto but rotatable within it;
a fixed jaw mounted on the main vice screw, the jaws being moveable toward or away from one another upon rotation of the main vice screw; and
a quick release mechanism, including a screw-threaded element moveable between:
a closed position in which the screw-threaded element engages the screw-thread of the main vice screw; and
an open position in which the screw-threaded element is disengaged from the main vice screw, thereby enabling the main vice screw to be moved freely axially with respect to the fixed jaw,
wherein movement of said screw-threaded element between said closed and open positions is effected by rotation of the main vice screw.

2. Vice as claimed in claim 1, wherein said quick release mechanism further comprises an actuator disposed on said main vice screw which urges said screw-threaded element into engagement with the main vice screw when the main vice screw is rotated in a direction that brings the vice jaws towards one another.

3. Vice as claimed in claim 2, in which said actuator is a frictional fit on said main vice screw.

4. Vice as claimed in claim 3, wherein the actuator further comprises a retaining hook for maintaining the relative axial position of the actuator and said screw-threaded element.

5. Vice as claimed in claim 3, wherein said actuator is a leaf spring comprising a collar around the main vice screw, and elongate leaves which move said screw-threaded element into and out of engagement with said main vice screw.

6. Vice as claimed in claim 2, wherein said mechanism comprises a nut body, and said actuator is mounted on said our body for movement relative thereto.

7. Vice as claimed in claim 6, wherein said nut body is fixed in the fixed law and comprises a sleeve which is a sliding fit on the main vice screw.

8. Vice as claimed in claim 6, wherein said actuator is a leaf spring comprising a collar around the main vice screw, and elongate leaves which move said screw-threaded element into and out of engagement with said main vice screw, and wherein the nut body comprises cam surfaces over which the elongate leaves can travel in order to effect said movement.

9. Vice as claimed in claim 1, in which said screw-threaded element comprises two half nuts which, in the closed position, substantially surround the main vice screw.

10. Vice as claimed in claim 9 wherein said mechanism comprises a nut body, and said actuator is mounted on said nut body for movement relative thereto, and wherein said half nuts are mounted in the nut body.

11. Vice as claimed in claim 10, wherein said nut body is fixed in the fixed jaw and comprises a sleeve which is a sliding fit on the main vice screw.

12. Vice as claimed in claim 11, wherein said actuator is a leaf spring comprising a collar around the main vice screw, and elongate leaves which move said screw-threaded element into and out of engagement with said main vice screw, and wherein the nut body comprises cam surfaces over which the elongate leaves can travel in order to effect said movement.

13. Vice as claimed in claim 9, wherein the half nuts are pivotally mounted so as to enable them to pivot between the open and the closed positions.

14. Vice as claimed in claim 1, wherein the quick release mechanism, when it is in said closed position, is axially shiftable between axial limits in the fixed jaw by rotation of the main vice screw, said limits defining a first locked position, wherein said mechanism is prevented from moving to said open position, and an unlocked position in said mechanism can move to said open position.

15. Vice as claimed in claim 14, wherein said mechanism comprises a nut body, said nut body having a chamfer, and said actuator is mounted on said nut body for movement relative thereto, and wherein said actuator is chamfered and engages said chamfer in said nut body when in said first locked position.

16. Vice as claimed in claim 15, wherein said nut body is fixed in the fixed jaw and comprises a sleeve which is a sliding fit on the main vice screw, and wherein said chamfer comprises an internal, circumferential edge of the sleeve.

17. Vice comprising a moveable jaw mounted on a screw-threaded main vice screw which is axially fixed with respect to said moveable jaw but is rotatable within it, a fixed jaw mounted on the main vice screw, the jaws being moveable toward or away from one another upon rotation of the main vice screw, and a quick release mechanism including a screw-threaded element moveable between an engaged position in which the screw-threaded element engages the screw-thread of the main vice screw and a disengaged position in which the screw-threaded element is disengaged from the main vice screw enabling the main vice screw to be moved freely axially with respect to the fixed jaw, in which the mechanism, when it is in said engaged position, is axially shiftable between axial limits in the fixed jaw by rotation of the main vice screw, said limits defining a first locked position, wherein said mechanism is prevented from moving to said disengaged position, and an unlocked position in said mechanism can move to said unlocked position.

18. Quick release mechanism for use in a vice of the type comprising:
a screw-threaded main vice screw;
a moveable jaw mounted on said main vice screw and axially fixed with respect thereto but rotatable within it;
a fixed jaw mounted on the main vice screw, the jaws being moveable toward or away from one another upon rotation of the main vice screw;
said quick release mechanism, comprising:
a nut body; and
a screw-threaded element mounted on the nut body and moveable between:
a closed position in which the screw-threaded element engages the screw-thread of the main vice screw; and
an open position in which the screw-threaded element is disengaged from the main vice screw, thereby enabling the main vice screw to be moved freely axially with respect to the fixed jaw,
wherein movement of said screw-threaded element between said closed and open positions is effected by rotation of the main vice screw.

19. Mechanism as claimed in claim 18, wherein said screw-threaded element comprises two half nuts which, in the closed position, substantially surround the main vice screw.

20. Mechanism as claimed in claim 18, wherein said quick release mechanism further comprises an actuator adapted to be disposed on said main vice screw to urge said screw-threaded element into engagement with the main vice screw when the main vice screw is rotated in a direction that brings the vice jaws towards one another.

21. Mechanism as claimed in claim 20, wherein the actuator further comprises a retaining hook for maintaining the relative axial position of the actuator and said screw-threaded element.

22. Mechanism as claimed in claim 20, wherein said actuator is a leaf spring comprising a collar adapted to be a frictional fit around the main vice screw, and elongate leaves which are adapted to move said screw-threaded element into and out of engagement with said main vice screw by engagement with said nut body on rotation of said main vice screw.

23. Mechanism as claimed in claim 18, wherein said nut body is adapted to be fixed in the fixed jaw and comprises a sleeve adapted to be a sliding fit on said main vice screw.
